(19) United States
(12) Patent Application Publication
(10) Pub. No.: US 2005/0151050 A1
(43) Pub. Date: Jul. 14, 2005

(54) Ice cube tray

(76) Inventor: Michael Godfrey, Toronto (CA)

Correspondence Address: IAN FINCHAM, SUITE 606, 225 METCALFE STREET, OTTAWA, ON, K2P 1P9, CA

(21) Appl. No.: 11/033,820

(22) Filed: Jan. 13, 2005

Related U.S. Application Data
(60) Provisional application No. 60/535,831, filed on Jan. 13, 2004.

(51) Int. Cl. B28B 7/06

(52) U.S. Cl. 249/127

(57) ABSTRACT

An improved ice tray having a plurality of cavities to permit individual ice cubes to be removed on an individual basis, each of the cavities including a flexible bottom wall, such that when pressure is applied to the flexible bottom wall the ice cube therein is raised upwardly to expose a portion of the ice cube to enable a user to remove the desired individual cube.

This application claims the priority of U.S. provisional patent application Ser. No. 60/535,831, filed Jan. 13, 2004, the entire disclosure of which is incorporated herein by reference.

### FIELD OF THE INVENTION

The present invention relates to containers for freezing small cubes or blocks of ice, and more specifically to an ice cube tray or mold having a torsionally flexible upper portion and a flexible bottom wall being of a second material.

### BACKGROUND OF THE INVENTION

Common household stackable ice trays or ice cube trays are generally acceptable for the production and quality of uniform ice cubes, however it is difficult to remove an individual ice cube when desired by the user.

Typically, a hard material (for example plastic or light metal) is used in the construction of an tray. The design of a typical ice tray permits a user to fill the tray so that the level of water is flush with the top of the individual ice cube holder, in order to make a full cube. This filling of the receptacle or tray prohibits any grip on a cube when frozen.

Further, the construction material of prior art trays is designed to give some lateral flex when removing the ice cubes from the tray in order to initially “break the seal” of the ice-to-tray bond. When freshly frozen ice is removed from the freezer, the material in the individual ice cube holders located in the tray does not easily bend and actually becomes harder which makes it very difficult to remove an individual ice cube.

A common solution to this problem is to turn the ice cube tray upside down to remove the ice cubes which generally results in releasing all of the cubes in the tray, instead of retrieving the one desired.

An advantage of the present invention is to permit a combination of at least two different materials combined in a single unitary tray to enable a user to make ice in the traditional way, by filling the tray or receptacle with water or a liquid, freezing the contents therein container resulting in a desirable and familiar ice cube form, and allow the user to retrieve an individual ice cube a much easier task.

Advantageously, from a manufacturing standpoint, the present invention may be achieved at a very competitive price with a very novel result compared with the standard off the shelf ice cube tray.

### SUMMARY OF THE INVENTION

According to one aspect of a preferred embodiment of the present invention, there is provided an ice cube tray comprising a semi-flexible tray including a plurality of individual downwardly tapering receptacles, each of the receptacles including a plurality of side walls, wherein the tray and plurality of sidewalls comprises a first semi-flexible material, each receptacle including a flexible material bonded to the sidewalls forming a bottom wall.

According to another aspect of the present invention there is provided an ice tray, comprising a semi-flexible tray including a plurality of individual downwardly tapering receptacles, each of the receptacles including side walls and a bottom wall, the bottom wall including an aperture therein, whereby the tray and walls comprise a semi-flexible material, and a plug member adapted to sealingly engage with the aperture of the bottom wall of each receptacle, the plug member comprising a flexible material.

According to yet another aspect of the present invention there is provided an ice tray comprising a tray having a plurality of individual receptacles, comprising a semi-flexible grid-like structure, each of the receptacles formed with depending side walls and a bottom wall, the bottom wall including at least one aperture therein, and each of the receptacles including a flexible plug member of a material different to the material of the tray and receptacle side walls adapted to seal the aperture.

According to yet another aspect of the present invention there is provided an ice tray comprising a tray having a plurality of individual receptacles, comprising a semi-flexible grid-like structure, each of the receptacles formed with depending side walls, and each of the receptacles comprising a flexible bottom wall of a material different to the material of the tray and receptacle side walls.

Other features and advantages of the present invention will become more readily apparent to those of ordinary skill in the art after reviewing the following description and accompanying drawings.

### BRIEF DESCRIPTION OF THE DRAWINGS

The present invention will be more fully understood by reference to the following drawings in which:

FIG. 1 is a perspective view of an ice tray of a first embodiment of the present invention;

FIG. 2 is a bottom view of the ice tray of FIG. 1;

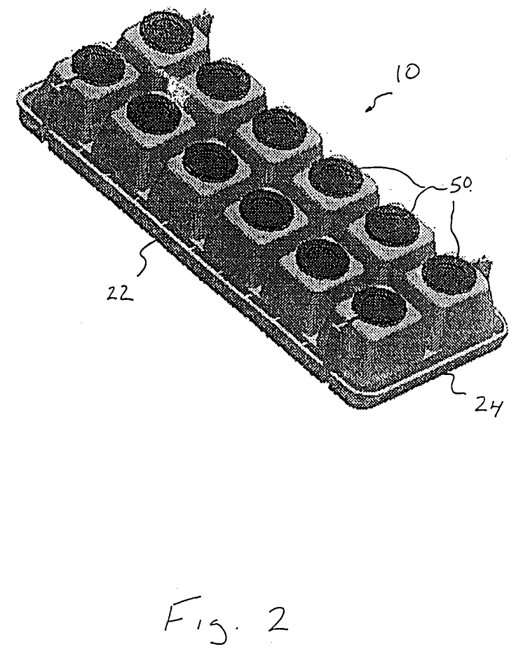

FIG. 3 is an exploded bottom view of FIG. 2 with the bottom plugs removed;

FIG. 4 is an enlarged top view of the interior of the receptacle of FIG. 1, and

FIG. 5 is an enlarged bottom view of FIG. 2.

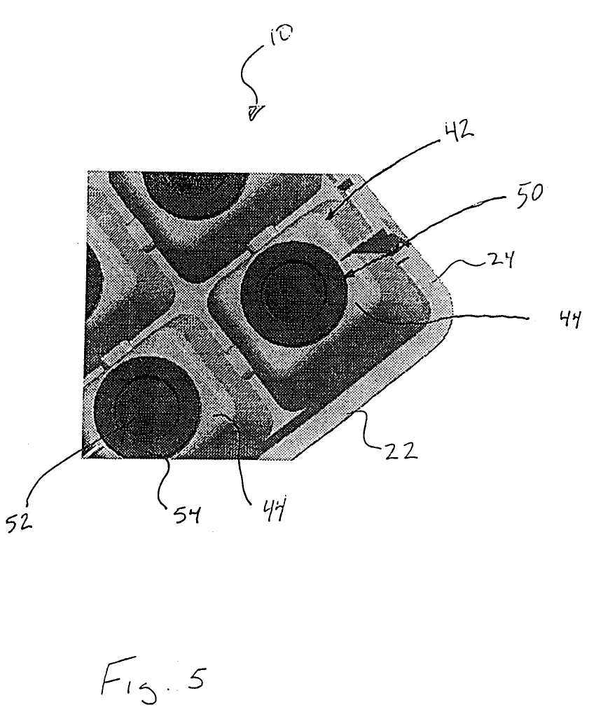

### DESCRIPTION OF THE PREFERRED EMBODIMENTS

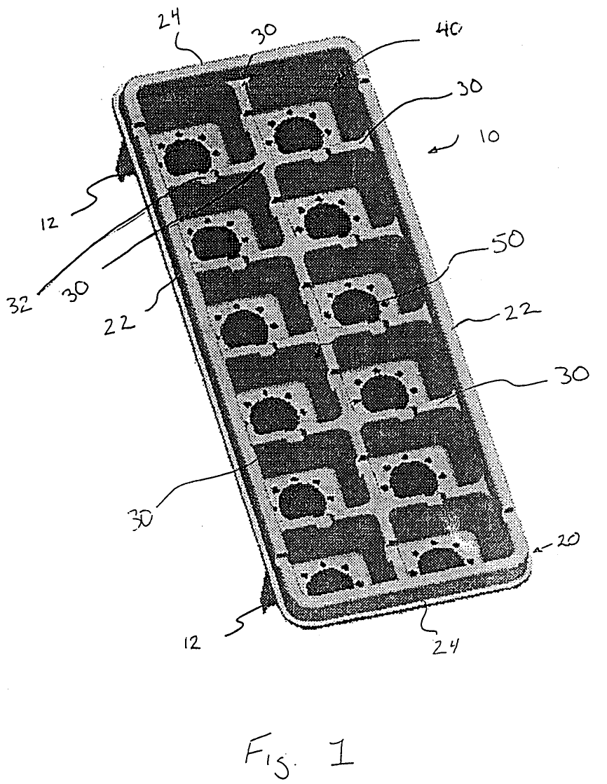

With reference to the accompanying drawing Figures, and more particularly to FIG. 1, there is illustrated a container generally indicated by reference numeral 10. The ice cube tray 10 includes an upper surface 20, a plurality of inner walls 30 which define a plurality of individual receptacles or compartments 40, each receptacle being adapted to retain a liquid for freezing a single ice cube or block of generally cubical or other conventional form, and a plug member 50.

The compartments or receptacles 40 are preferably arranged in a conventional manner, for example, arranged in longitudinal and transverse rows and are of a total number depending on the desired size and use of a particular tray. The upper portion of the tray 20 may include narrow flanges or the like on each of the four edges, and may further include a tab or similar projection to facilitate removal of the tray 10 from a freezer compartment by a user. Legs or supports 12 may also be provided on the tray 10 to facilitate tray stacking, stability and to reduce interference with ice formation. As illustrated, these supports 12 are mounted to an exterior surface of a receptacle 40 at each of the corners to provide stability thereto, however other locations and shapes may be similarly utilized.

The tray or receptacle 10 is preferably manufactured utilizing two different types of materials which are bonded or otherwise joined together. As illustrated and described herein, two different types of plastic material are used in the manufacture of the present invention; one of the plastics having increased flexibility than the other, whereby each is preferably bonded to the other to make a unitary one piece tray. It should be understood by those skilled in the art to which the present invention relates that the present invention may also be utilized using one or more materials.

As illustrated in FIG. 1, the tray 10 is of a generally rectangular configuration and includes a continuous upper tray portion 20, the upper tray portion 20 including a pair of lateral sidewalls 22 and a pair of lateral end walls 24. Integrally formed within the boundary defined by the outer walls 22 and 24, there is provided a network of upper wall members 30 which form a plurality of receptacles or ice cube molds generally indicated by the reference numeral 40. The inner wall members 30 as illustrated are integrally formed so as to provide a conventional grid-work, of longitudinally and latitudinally oriented walls.

As described in greater detail below, the inner walls 30 on an upper surface thereof may include a notch 32 or the like to permit a liquid to easily pass into an adjacent receptacle 40, for example during filling of the receptacle.

Each receptacle 40 can be of any suitable size or shape for forming an ice cube therein; accordingly the term ice cube used herein is understood to include a formation of a frozen liquid into any suitable size and shape. The shape and or configuration of the inner walls 30 may be conventional or typical of the shaped ice trays commonly used, however other shapes and configurations may also be used with the present invention. Such shapes may include but are not limited to, rectangular, cone, square, polygonal etc. With respect to the receptacles 40, each individual receptacle is separated from an other receptacle via the upper wall members 30.

The upper portion 20 of each tray is preferably made of a semi-flexible plastic which retains is adapted to maintain its flexibility under sub-zero temperatures typically found in refrigerators or freezers. The upper tray portion 20 and the inner wall members 30 defining each individual mold 40 is resiliently twistable to loosen all of the ice cubes or pieces simultaneously.

The drawings in the present application and their accompanying detailed description are directed to merely exemplary embodiments of the invention. To maintain brevity, other embodiments of the invention which use the principles of the present invention are not specifically described in the present application and are not specifically illustrated by the present drawings.

As illustrated in the attached drawing Figures, and in particular to FIG. 1, each mold or ice cube receptacle 40 includes depending inner walls 42 and a bottom wall 44. As noted above, the tray portion 20, including the depending receptacles 40 (when viewed in cross section) are of a first material having an increased rigidity than that of the bottom wall 44, discussed in greater detail below. As illustrated, the inner sidewalls 42 of each of the receptacles 40 depend downwardly from the upper surface of the tray 10, and may be slightly tapered to facilitate removal of the ice cubes therein.

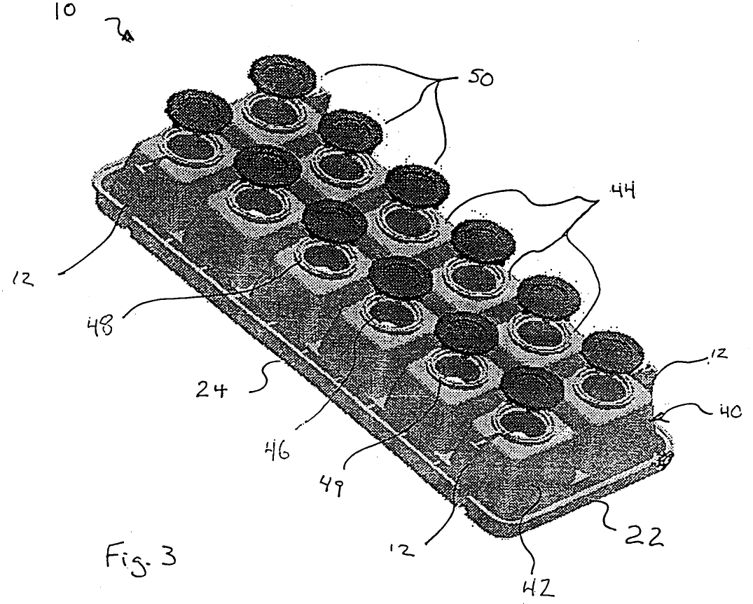

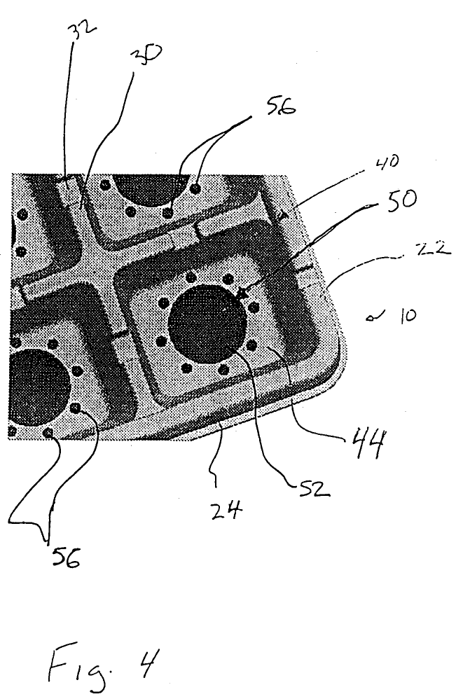

As illustrated in FIGS. 3 and 4, the bottom wall 44 includes a centrally located aperture 46, having a channel member 48 surrounding the aperture on the exterior or outward facing portion of the bottom wall 44. As illustrated, the channel member 48 on the exterior of the bottom wall 44 is adapted to receive and retain therein a mating or corresponding member on the circular plug member 50.

As illustrated in FIG. 4, the bottom wall 44 of each individual ice cube receptacle 40 is adapted to receive a plug member 50, which is of a flexible (i.e., rubber or elastomeric plastic) material adapted to retains it's flexibility or elasticity in sub-zero temperatures, typically found in household freezers or the like. The bottom wall 42 of the mold or receptacle 30 is adjoined or otherwise bonded to the more flexible material of the member 50, discussed in greater detail below.

As illustrated, the plug member 50 is configured as a generally circular dome or plug shaped member. The member 50 is preferably formed with a central dome 52 on one side thereof and an annular ring or flange portion 54 extending about the periphery of the dome 52. The generally circular member 50 is adapted to be positioned or otherwise adjoined to the bottom wall 44 of the receptacle 40. As illustrated, the bottom wall 44, which includes a centrally located aperture 46, is of sufficient width is adapted to permit at least a portion of the dome 52 of the plug member 50, to extend therethrough when in use by a user to permit the raising and extraction of an ice cube from within the receptacle.

According to another embodiment of the present invention, the tray of the present invention may include a flexible bottom wall instead of a plug member as described above. As contemplated, the tray would be similar to that as described above, with the exception that the lower portion of each receptacle, for example from a point immediately above the point where the sidewall 42 inwardly curves to form the bottom wall 44 of the preceding embodiment, would be replaced by a flexible material and adjoined to the sidewalls. As such, the entire portion of the bottom wall 44 would be manufactured of the more flexible material in comparison to that of the semi-flexible material of the upper portion of the tray 20 described above. Suitable manufacturing processes known to those skilled in the art would be utilized to provide a seamless edge to prevent the ice cube from sticking to the interior surface.

In accordance with the above alternative embodiment, the bonding or joining of the flexible material of the flexible bottom wall to the lower portion of each receptacle forms a seamless bond so that the ice cube, once formed, will not stick to the receptacle.

The bottom member as contemplated in this alternative embodiment, may be of any conventional configuration, such as circular, rectangular, square, polygonal etc., as long as the configuration lends itself to remain flexible under zero or sub-zero temperatures and permits the desired shape to flex.

In use, a tray, in accordance with the alternative embodiment described hereinabove, is removed from the freezer unit of a refrigerator or freezer, after which the tray is distorted or flexed, or torsionally twisted to “break the ice” or the upper most layer of frozen liquid which may reside in the tray after expansion of the liquid during freezing. When a user wishes to retrieve an individual ice cube from the tray, after breaking the ice in the similar fashion to that of existing plastic ice trays, the user pushes or presses inwardly on the flexible plug bottom to raise the individual ice cube within the receptacle. The upward pressure by a user's finger or the like forces the flexible bottom portion that retains the desired cube inwardly, and forces the ice cube up and out of the tray or mold.

As such, this upward pressure forces the desired cube and only that cube to separate from the tray, leaving the remaining cubes in their respective molds.

Alternatively, if there is no upper most layer of ice, a user may simply effect upward pressure on the bottom wall or plug member to dislodge an individual ice cube from the tray without having to torsionally twist the tray itself.

Although preferred embodiments of the invention have been described above, it is not limited thereto and it will be apparent to those skilled in the art that numerous modifications form part of the present invention insofar as they do not depart from the spirit or scope of the invention as defined in the accompanying claims.

1. An ice tray, comprising:
a semi-flexible tray including a plurality of individual downwardly tapering receptacles, each of the receptacles including side walls and a bottom wall, the bottom wall including an aperture therein, whereby the tray and walls comprise a semi-flexible material, and
a plug member adapted to sealingly engage with the aperture of the bottom wall of each receptacle, the plug member comprising a flexible material.

2. An ice tray according to claim 1, wherein the plug is bonded to the bottom wall of the receptacle.

3. An ice tray according to claim 1, wherein the bottom wall includes a plug receiving member.

4. An ice tray according to claim 3, wherein the plug receiving member includes a channel member on an exterior portion of the bottom wall.

5. An ice tray comprising:
a tray having a plurality of individual receptacles, comprising a semi-flexible grid-like structure, each of the receptacles formed with depending side walls and a bottom wall, the bottom wall including at least one aperture therein, and
each of said receptacles including a flexible plug member of a material different to the material of the tray and receptacle side walls adapted to seal the aperture.

6. An ice tray according to claim 1, wherein the flexible material is bonded to the sidewalls.

7. An ice tray comprising:
a tray having a plurality of individual receptacles, comprising a semi-flexible grid-like structure, each of said receptacles formed with depending side walls, and each of said receptacles comprising a flexible bottom wall of a material different to the material of the tray and receptacle side walls.

8. An ice tray according to claim 7, wherein the flexible material is bonded to the sidewalls to form the bottom wall.

9. An ice tray according to claim 2, wherein the bond is seamless.

10. An ice tray according to claim 6, wherein the bond is seamless.

11. An ice tray according to claim 8, wherein the bond is seamless.

12. An ice tray according to claim 1, wherein the receptacles are downwardly tapered.

13. An ice tray according to claim 5, wherein the receptacles are downwardly tapered.

14. An ice tray according to claim 7, wherein the receptacles are downwardly tapered.
